(19) United States
(12) Patent Application Publication
(10) Pub. No.: US 2006/0289394 A1
(43) Pub. Date: Dec. 28, 2006

(54) TIG welding or braze welding with metal transfer via a liquid bridge

(76) Inventors: Olivier Revel, Pierrelaye (FR); Thomas Opderbecke, Saint Ouen I'Aumone (FR); Pascal Bertin, Chaumont en Vexin (FR)

Correspondence Address: AIR LIQUIDE, 2700 POST OAK BOULEVARD, SUITE 1800, HOUSTON, TX, 77056, US

(21) Appl. No.: 11/471,180

(22) Filed: Jun. 20, 2006

(30) Foreign Application Priority Data
Jun. 22, 2005 (FR) 0551709

(51) Int. Cl. B23K 9/167

(52) U.S. Cl. 219/75

(57) ABSTRACT

The invention relates to a arc welding process employing a TIG torch provided with a non-consumable electrode and a consumable filler wire, the end of said consumable wire being progressively melted by an electric arc generated between the non-consumable electrode and at least one workpiece to be welded so as to transfer molten metal from the wire to said workpiece and thus obtain a welded joint. The consumable wire is fed in at an angle of less than 50° to the axis of the electrode. Metal is transferred to the welded joint via a liquid bridge so that there is permanent contact between the puddle of molten metal forming the welded joint and the melted end of the filled wire.

This application claims the benefit of priority under 35 U.S.C. § 119 (a) and (b) to French Application No. 0551709, filed Jun. 22, 2005, the entire contents of which are incorporated herein by reference.

### BACKGROUND

The present invention relates to a welding process, preferably a robotic welding process, using a TIG torch and filler metal in the form of one or more consumable wires.

A conventional TIG torch configuration with a consumable filler wire is known from documents U.S. Pat. No. 5,512,726 and DE-A-3542984, in which the consumable wire is fed into the molten puddle horizontally or almost horizontally so as to be able to transfer molten metal as droplets from the consumable end of the melted wire into the welding zone, that is to say to the workpieces to be welded or braze-welded together.

This type of torch configuration has disadvantages. In particular, since the only force present for transferring the metal to the welding zone is gravity, metal transfer by droplets results in an irregular bead appearance, a risk of contaminating the non-consumable tungsten electrode by inopportune contact with one or more metal droplets, and sometimes difficulties in carrying out the work in position, especially in confined spaces or spaces that are difficult to access.

In addition, given that during implementation of such a process a certain directionality is needed in order to orient the wire feed along the axis of the joint to be welded, the sixth axis of the robot carrying the TIG torch is blocked and its degrees of freedom are therefore limited.

Moreover, it is known that, with this type of configuration, the productivity of the process is adversely affected, especially in terms of welding speed, wire feed speed and deposition rate.

The problem that arises is therefore how to improve existing robotic filler-metal TIG welding processes so as to be able to weld with a high productivity, especially with a welding speed of at least 50 cm/min., and with good quality, that is to say with the absence of spatter, silicates and oxides, so as to facilitate the robotization of these filler-metal TIG processes and to enhance their performance.

One solution of the invention is a arc welding process employing a TIG torch provided with a non-consumable electrode and a consumable filler wire, the end of said consumable wire being progressively melted by an electric arc generated between the non-consumable electrode and at least one workpiece to be welded so as to transfer molten metal from the wire to said workpiece and thus obtain a welded joint, characterized in that the consumable wire is fed in at an angle (α) of less than 50° to the axis of the electrode; the end of the consumable wire is guided and kept permanently at a distance (D) of less than 2 mm from the end of the tungsten electrode; and metal is transferred to the welded joint via a liquid bridge so that there is permanent contact, that is to say contact maintained during welding, between the puddle of molten metal forming the welded joint and the melted end of the filled wire.

Depending on the case, the process of the invention may include one or more of the following features:
the welding is carried out with a wire speed (V_{wire}) ranging up to 20 m/min., in particular between 1 and 10 m/min, depending on the wire diameter used;
several metal workpieces are welded together;
the consumable wire is fed in at an angle of between 10° and 25°, preferably about 15 to 20°, to the axis of the electrode;
the end of the consumable wire is guided and kept permanently at a distance of less than 1.5 mm, preferably approximately 1 mm, from the end of the tungsten electrode of the TIG torch. However, in all cases, the surface of the end of the wire must not come into contact with the tungsten electrode;
during welding, a gas shield is provided around the welded joint being formed, around the tungsten electrode and around the wire;
a gas shield consisting of a gas chosen from argon, helium, nitrogen and argon/hydrogen mixtures is provided;
it is carried out on a robotic welding arm carrying a non-consumable-electrode TIG torch and means for feeding it with consumable welding wire, or manual or automatic welding mode;
it is carried out in order to weld or braze one or more workpieces made of steel, especially galvanized or zinc-plated steel, aluminum, stainless steel or other metallic materials;
the current supplied to the TIG torch is between 10 A and 400 A and the voltage is between 10 V and 20 V; and
the wire has a diameter of between 0.6 mm and 1.6 mm with a wire speed of up to 20 m/min., depending on the diameter of the wire used.

The process of the invention therefore relies on the fact of transferring molten metal in the form of a liquid bridge or a stream of liquid metal between the filler wire and the zone to be welded so as to maintain permanent contact between the puddle of molten metal and the filler metal.

In other words, metal is not transferred drop by drop, as in the prior art, but via a liquid bridge of molten metal.

Transfer via a liquid bridge according to the invention may be achieved within a broad range of wire feed speed parameters which is high compared with conventional TIG processes.

However, this type of transfer may be difficult to achieve with a conventional torch configuration since, in such a torch, the wire is directed so as to be parallel or horizontal to the surface of the workpiece(s) to be welded, and therefore touches the weld puddle without being transferred into the arc.

Thus, the process of the invention is preferably carried out using a torch with the consumable wire passing through the wall of the nozzle at an angle (α) of less than 50°, for example a torch similar or identical to that described in document EP-A-1 459 831.

The wire feed, which is built into the torch, takes place at an angle (α) of generally about 10° to 20°, for example about 15° to 20°, to the axis of the non-consumable electrode of the torch and to do so while maintaining a short distance between the end of the wire and the tip of the tungsten electrode cone, for example approximately 1 mm or the diameter of the filler wire.

In all cases, to obtain effective transfer of metal via a liquid bridge, the end of the consumable wire is guided and kept permanently at a distance D of less than about 2 mm from the end of the tungsten electrode, that is to say the distance between the external surface of the consumable wire and the electrode must not exceed about 2 mm, preferably about 1 mm. This is because if the wire/electrode distance D becomes too great, that is to say greater than 2 mm, it becomes very difficult, if not impossible, to achieve effective and durable transfer via a liquid bridge.

The configuration of such a torch therefore makes it possible to implement the process of metal transfer via a liquid bridge in robotic, automatic and manual welding.

An alternative application may be a torch configuration with two wire feeds located on opposite faces perpendicular to the joint plane. This makes it possible to carry out overlay or resurface applications or applications for forming very wide beads, as this makes it possible to increase the tolerance on the gap between the workpieces to be welded.

Transfer via a liquid bridge according to the invention has the following advantages:
a point of impact beneath the arc, thereby making it easier to position the torch;
uninterrupted metal transfer, well directed into the puddle;
an attractive appearance of the high-quality weld bead;
constant presence of a transfer force by surface tension makes in-position work easier;
ease of adjusting the wire speed parameter, since a wire surplus can be absorbed in the puddle;
formation of multidirectional weld beads without changing the orientation of the wire at the TIG torch;
the wire passes through the hottest zones of the arc. This has a preheating effect on the wire and increases both the efficiency and the speed. This phenomenon is similar to the “hot wire” process described by U.S. Pat. No. 2,791,673 in which the preheating is carried out by Joule heating in the filler metal. However, according to the invention, the preheating energy is provided directly by the electric arc and not by a different energy source, as in the “hot wire” process;
after welding and extinction of the arc, the wire is cut so as to be pointed, thereby making it easier to melt the wire during formation of a new bead; and
a possibility of achieving welding synergies, as in the case of the MIG/MAG welding process. The preferred wire speed is given according to the various parameters chosen by the operator, namely material to be joined, nature and diameter of the filler wire, current, shielding gas, welding speed, etc.

The invention will be more clearly understood thanks to the explanations given below with reference to the appended illustrative figures.

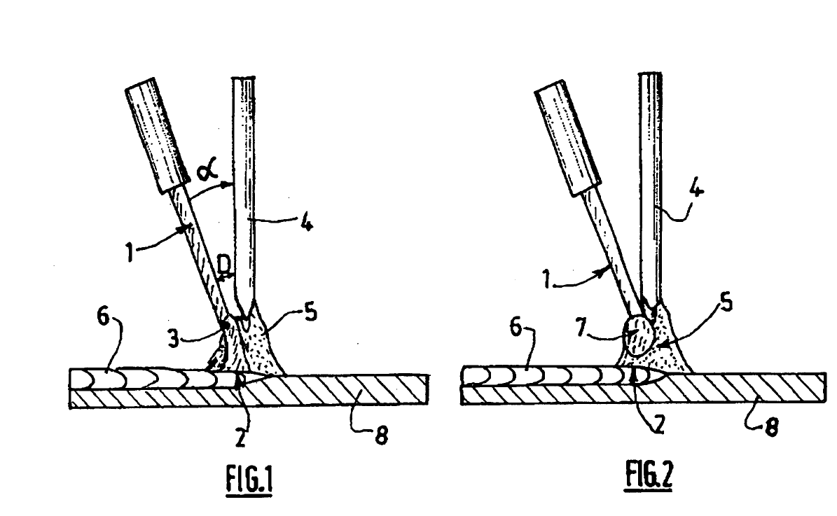

FIG. 1 illustrates what is meant by the expression “transfer via a liquid bridge” according to the invention, namely an uninterrupted passage of the filler metal 3 which is melted in the electric arc 5 generated by the tungsten electrode 4 between the end of the filler wire 1 and the puddle of molten metal 2 by means of a stream or bridge of molten metal 3, so as to obtain the desired welded joint 6 between the workpieces 8 to be joined together by welding.

As may be seen, the consumable wire 1 is fed in at an angle (α) of generally around 10° to 20°, for example about 15° to 20°, to the axis of the non-consumable tungsten electrode and the surface or end of the consumable wire 1 is guided and kept permanently at a distance (D) of less than 2 mm from the surface of the end of the tungsten electrode 4.

FIG. 2 shows schematically a transfer via a droplet 7 according to the prior art. In this case, there is no permanent liquid bridge between the electrode 4 and the weld puddle 2 and, moreover, the end of the consumable wire is not usually guided or kept permanently at a distance of less than 2 mm from the conical end of the electrode.

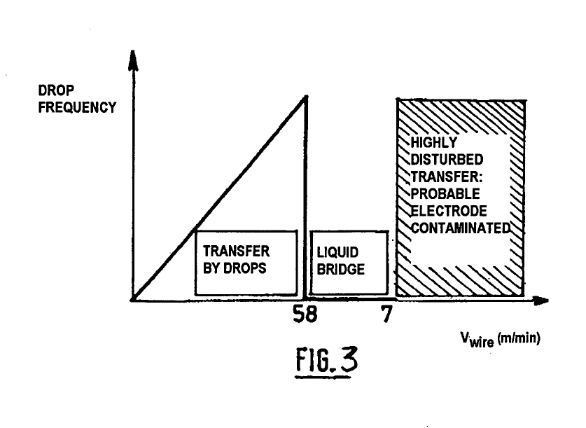

FIG. 3 illustrates the frequency of the drops as a function of the wire speed for a current of 200 A, a welding speed of 2 m/min and a CuSi₃ wire 1 mm in diameter.

In the field of transfer by drops, increasing the wire speed means that the drop frequency is increased up to the occurrence of a threshold at which transfer takes place by a liquid stream with a zero drop frequency.

The table below gives examples of welding parameters to be adopted in order to carry out the process of the invention in the case of a welding speed (V_{w}) of between 100 and 200 cm/min and for a wire angle of about 15° to 20° and an electrode/wire distance (D) of about 1 mm.

TABLE

| | | | | | | Min. | Max. | | |
|---|---|---|---|---|---|---|---|---|---|
| Welded | Thickness | | | U | I | V_{wire} | V_{wire} | V_{weld} | |
| material | (in mm) | Gas | Wire | [V] | [A] | (m/min) | (m/min) | (m/min) | Configuration |
| Carbon | 2 | Arcal | G3Si1 | 11 | 160 | 1 | 1.6 | 1 | Outside |
| steel | | 10 | Ø1 | | | | | | corner |
| Galvanized | 1 | Arcal | CuSi3 | 13 | 200 | 5.8 | 7 | 2 | Lap |
| carbon | | 10 | Ø1 | | | | | | |
| steel | | | | | | | | | |
| (10 μm) | | | | | | | | | |
| 304L | 2 | Arcal | 308 | 14.5 | 210 | 4.8 | 5.6 | 1.5 | Lap |
| stainless | | 10 | Ø1.2 | | | | | | |
| steel | | | | | | | | | |
| Galvanized | 1 | Arcal 1 | CuAl8 | 14 | 180 | 5.5 | 6.8 | 1.75 | Lap |
| carbon | | | Ø1 | | | | | | |
| steel | | | | | | | | | |
| (10 μm) | | | | | | | | | |
| Carbon | 1 | Arcal | CuSi3 | 13 | 150 | 3.2 | 3.8 | 1 | Fusion |
| steel | | 10 | Ø1 | | | | | | line |

ARCAL ™ 10 is a gas containing argon to which 2.5% by volume of hydrogen has been added, and ARCAL ™ 1 is a gas containing pure argon; these gases are sold by Air Liquide.

The minimum wire speed (min. V_{wire}) and maximum wire speed (max. V_{wire}) are those to be applied in order to achieve transfer via a liquid bridge. Below these speeds, transfer by drops is obtained, whereas above these speeds, perturbations in the process occur.

The transfer modes may be obtained on any type of material and on various joint configurations: butt joint, lap joint, corner joint and flanged-edge joint.

Furthermore, in order to validate the process of the invention, tungsten electrode lifetime tests were carried out.

These electrode lifetime tests were carried out on workpieces made of galvanized steel with a surface zinc coating 20 μm in thickness firstly without filler metal.

Under these conditions, 240 weld beads 1 m in length could be produced with 240 arc-strikes/beads and a total duration of 240 minutes welded without changing electrode. However, after these 240 arc strikes/beads, the terminal part of the tungsten electrode was worn, namely with the appearance of tungsten nodules.

The test was repeated under the same conditions but with a consumable filler wire and a “liquid bridge” in accordance with the present invention.

In this case, 270 arc strike/beads could be produced, i.e. 30 more beads, and to do so without appreciable occurrence of nodules on the end of the electrode.

Furthermore, a protective effect of the filler wire was observed, in which the electrode is protected from being contaminated by zinc vapour coming from the coating on the workpieces to be welded, given that the wire acts as a zinc vapour “screen”, preventing said vapour from contaminating the tungsten electrode.

These trials show the effectiveness of the process of the invention since it is possible to increase by about 10% the number of arc strikes and therefore the number of weld beads that can be produced with the same tungsten electrode under the above conditions, that is to say with a consumable filler wire.

By optimizing the welding parameters and conditions, it is even possible to hope to achieve an even greater gain.

The process of the invention can be used for welding any type of material and on various joint configurations, especially butt, lap or corner and flanged-edge joints.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. An arc welding process employing a TIG torch provided with a non-consumable electrode and a consumable filler wire, the end of said consumable wire being progressively melted by an electric arc generated between the non-consumable electrode and at least one workpiece to be welded so as to transfer molten metal from the wire to said workpiece and thus obtain a welded joint, wherein:
a) the consumable wire is fed in at an angle (α) of less than 50° to the axis of the electrode;
b) the end of the consumable wire is guided and kept permanently at a distance (D) of less than 2 mm from the end of the tungsten electrode of the TIG torch; and
c) metal is transferred to the welded joint via a liquid bridge so that there is permanent contact between the puddle of molten metal forming the welded joint and the melted end of the filled wire.

2. The process of claim 1, wherein the welding is carried out with a wire speed (V_{wire}) ranging up to 20 m/min., in particular between 1 and 10 m/min.

3. The process of claim 1, wherein the consumable wire is fed in at an angle (α) of between 10° and 25° to the axis of the electrode.

4. The process of claim 1, wherein the end of the consumable wire is guided and kept permanently at a distance (D) of less than 1.5 mm, preferably approximately 1 mm, from the end of the tungsten electrode of the TIG torch.

5. The process of claim 1, wherein, during welding, a gas shield is provided around the welded joint being formed, around the tungsten electrode and around the wire.

6. The process of claim 1, wherein a gas shield consisting of a gas chosen from argon, helium, nitrogen and argon/hydrogen mixtures is provided.

7. The process of claim 1, wherein it is carried out on a robotic welding arm carrying a non-consumable-electrode TIG torch and means for feeding it with consumable welding wire, or in manual or automatic welding mode.

8. The process of claim 1, wherein it is carried out in order to weld or braze one or more workpieces made of steel, especially galvanized or zinc-plated steel, aluminum, stainless steel or other metallic materials.

9. The process of claim 1, wherein the current supplied to the TIG torch is between 10 A and 400 A and the voltage is between 10 V and 20 V.

10. The process of claim 1, wherein the wire has a diameter of between 0.6 mm and 1.6 mm.

11. The process of claim 1, wherein several metal workpieces are welded together.
